(19) United States
(12) Patent Application Publication
(10) Pub. No.: US 2009/0164820 A1
(43) Pub. Date: Jun. 25, 2009

(54) METHODS AND APPARATUS FOR MANAGING POWER ON A COMPUTER IN THE EVENT OF A POWER INTERRUPTION

(75) Inventor: Benjamin ABRAHAM, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Houston, TX (US)

(21) Appl. No.: 11/963,969

(22) Filed: Dec. 24, 2007

(51) Int. Cl. G06F 1/28; G06F 11/30

(52) U.S. Cl. 713/323; 713/340

(57) ABSTRACT

A computer power management system, comprises a source of primary power, a motherboard, and an uninterruptible power system (UPS) including a power sensing circuit, a battery charger, a battery and power regulator module, a switching device, and control logic. The power management system operates to manage power on a computer in the event of a power interruption by: monitoring primary input power to a computer; delivering battery derived power from a battery internal to the computer to a subset of the computer's components; disabling at least one of a user input device and/or user output device; and saving zero or more open files to a storage device. Sizing the UPS to deliver only that amount of power required to save open files minimized cost and size of the computer.

### BACKGROUND

Many personal computers are powered directly from the local utility company, and as such are subject to instantaneous dips in voltage, or complete loss of voltage for an indeterminate length of time. Notwithstanding existing hardware and software that may detect an imminent loss of power and gracefully shut down the computer, loss of data occurred due to power fluctuations/outages results in loss of time and money. In many cases, the response time of computer components such as hard drives precludes the ability to save unsaved data when power is lost. In other scenarios, data may be destroyed or hardware may be physically damaged.

Approaches to preventing loss of data when input power to a computer is lost include power management systems including external battery backup systems that provide power to one or more computers and/or computer components when the normal source of power fails. There are, in the industry today battery backup systems that include battery chargers and inverters that convert an input alternating current (AC) line voltage to a direct current (DC) voltage to charge a battery. The DC voltage of the battery is used to generate a stable AC voltage which supplies a connected computer or other AC driven device.

Furthermore, some portable computers, e.g., laptop and notebook computers, are powered via a DC voltage from a power adapter, wherein circuitry integral to the portable computer both charges an internal battery as well as supplies the computer's components, which may include a processor board, a display device, memory and storage devices through one or more DC to DC voltage regulators. When the DC voltage supplying the computer fails, such as due to a loss of local AC power, the computer detects the condition and switches the inputs of the voltage regulators to the internal battery, supplying power to all computer components to thereby allow a user to continue operation until power is restored, or until the battery is exhausted.

Desktop computers are used throughout the world in power environment that are less than ideal, risking the loss of critical data. Depending upon the power requirements of the particular desktop computer and connected display device, providing an uninterruptible power system (UPS) to a computer and display device may be prohibitively expensive for a single computer user. Even for small businesses, adding a separate, external UPS is an additional expense.

### DESCRIPTION OF THE DRAWINGS

One or more embodiments are illustrated by way of example, and not by limitation, in the figures of the accompanying drawings wherein elements having the same reference numeral designations represent like elements throughout and wherein:

FIG. 1 is a block diagram of a desktop computer implementing a power management system according to an embodiment of the present invention;

FIG. 2 is a flowchart depicting a method according to an embodiment of the present invention;

FIG. 3 is a flowchart depicting a method executed by a computer according to an embodiment of the present invention;

FIG. 4 is a block diagram of an alternate computer according to an embodiment of the present invention comprising an internal display device; and

FIG. 5 is another flowchart depicting a method executed by a computer according to an embodiment of the present invention.

### DETAILED DESCRIPTION

The apparatus and methods described herein relate to a computer power management system comprising a computer with an integral uninterruptible power system (UPS) that allows a predetermined subset of computer components to operate for a time sufficient to save data in the event of an interruption to primary input power.

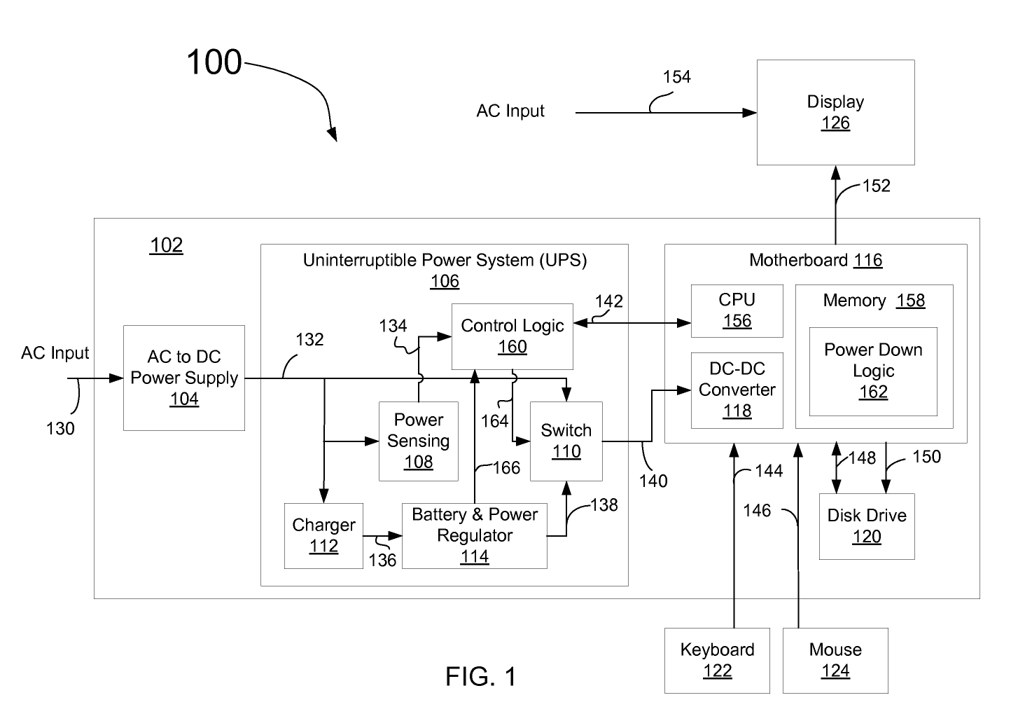

FIG. 1 depicts a personal computer system 100 comprising a housing 102 that further comprises an AC to DC power supply 104, a UPS module 106, a motherboard 116; and at least one disk drive 120. Motherboard 116 comprises a plurality of components that in at least some embodiments includes a central processing unit (CPU) 156, DC-DC converter module 118, and one or more memory modules 158 that may further comprise random access memory (RAM) memory, flash memory, read only memory (ROM) memory, programmable ROM (PROM), electrically programmable ROM (EPROM), electrically erasable PROM (EEPROM), registers, or another form of storage medium.

In at least some embodiments, power down logic 162, may be embodied directly in hardware, in a set of executable instructions stored in one or more memory modules 158, or in a combination thereof. Furthermore, in at least some embodiments, power down logic 162 is integral to CPU 156. In other embodiments, CPU 156 and power down logic 162 may reside in an application-specific integrated circuit (ASIC).

DC to DC converter module 118 delivers an array of DC output voltages matched to the DC input requirements of a computer system. In at least one configuration, user input devices, e.g., keyboard 122 and mouse 124, interface with motherboard 116 via data signals 144, 146, respectively. At least one disk drive 120 communicates with motherboard 116 over signal lines 148 deriving power from motherboard 116 via cable 150. An output device, e.g., display 126, receives AC input power from an AC source over cable 154, and receives display data via cable 152 from motherboard 116.

AC power is supplied to housing 102 by means of an AC input cable 130 electrically conducting local AC power to AC to DC power supply 104. In at least one embodiment power supply 104 converts a 120 VAC input signal to a low voltage DC signal 132, e.g., 12-18 volts DC. According to some alternate embodiments, AC to DC power supply 104 is a standalone module external to housing 102 and supplies power to housing 102 via a cable. In other embodiments, power supply 104 is mounted internal to housing 102.

Low DC voltage signal 132 is electrically connected to UPS module 106, which comprises power sensing unit 108, a battery charger 112, battery and power regulator 114, a switching unit 110, and control logic 160. Control logic 160 monitors the status of UPS module 106, including, but not limited to sensing unit 108, battery and regulator module 114 and switching unit 110. Control logic 160 interfaces with motherboard 116 via a bi-directional control interface 142, e.g., a universal serial bus (USB) or RS232 connection, and provides status of UPS module 106 to motherboard 116. In some embodiments UPS module 106 provides status upon request. In other embodiments, UPS module 106 generates an interrupt signal in response to a change of state of UPS module 106, e.g., a power interruption of DC input 132 or failure of a logic module.

Power sensing unit 108 monitors DC input voltage 132 and based upon characteristics of DC input voltage 132, e.g., voltage level and ripple, outputs data signal 134 to control logic 160. Based upon status information from power sensing unit 108 and from battery and power regulator module 114, control logic 160 determines whether to supply motherboard 116 with power over cable 140 from AC to DC power supply 104 or from battery and power regulator 114.

Battery and power regulator module 114 comprises a rechargeable battery, e.g., a Lithium Ion battery, and a power regulator that in some embodiments controls both the charging and output power characteristics of module 114. Furthermore, in some embodiments, battery and power regulator module 114 comprises an interface 166 to control logic 160 that in addition to providing status that may be communicated to motherboard 116, allows control logic 160 to determine the operational state of battery and power regulator 114 prior to switching to the battery and power regulator should primary input power 132 experience an interruption of power. In at least one disclosed embodiment, switch 110 includes a solid state switch to eliminate moving parts and to increase response time and reliability.

In addition to supplying low voltage DC to switch 110 and power sensing unit 108, low DC voltage signal 132 provides power to battery charger 112. Charger 112 is configured to provide a predetermined voltage and current to battery and power regulator module 114 in order to prevent overcharging the battery.

Unlike other UPS systems that allow a user to continue to operate computer 100 and output to an output device, e.g., display device 126, in the absence of AC input power for as long as possible, UPS 106 is sized to provide power to a predetermined subset of elements of computer system 100 for a predetermined amount of time necessary to save open files to disk 120 and then initiate a controlled shutdown of computer 106. In at least some embodiments, this subset comprises only motherboard 116 and disk drive 120. Furthermore, in some embodiments, power to drive 120 and other components, for example, user input devices e.g., keyboard 122 and mouse 124, is controlled through motherboard 116, whereby power down logic 162 is configured to enable or disable power to the connected devices. In other embodiments, a subset that receive power when computer 100 is placed in battery mode may include any connected device internal or external to housing 102 that derives power from motherboard 116.

In some embodiments, and depending upon the characteristics of the specific subset of components, the battery and power regulator module 114 is sized to provide up to approximately 10 minutes of power. In other embodiments wherein battery size and cost is of paramount importance, battery and power regulator 114 is sized to provide less than five minutes of power. Accordingly, the physical size and cost of UPS module 106 may be designed based upon available physical space, battery cost, and user backup requirements.

When motherboard 116 receives an indication from UPS 106 over interface 142 that DC voltage 132 has failed or has dropped below some predetermined threshold, power down logic 162, implemented in at least one of hardware or software, is configured to save zero or more files, e.g., open files, on disk drive 120 and initiate an orderly shutdown of computer 100. Alternatively, power down logic 162 is configured to place computer 100 in a hibernation state requiring a minimum amount of power. The file saving operation may be accomplished under control of the operation system (OS), the computer's BIOS, a separate hardware device, or a software program part of, or separate from, power down logic 162. In this manner, in one embodiment, computer 100 can reactivate itself when power is restored.

Furthermore, in at least some embodiments, the user is precluded from continuing to make use of the computer during file saving and other sequences of power down logic 162. Accordingly, in some embodiments, user input interface devices, e.g., keyboard 122 and mouse 124, are disabled, and/or have power removed therefrom to preclude their use by a user and to minimize power drain.

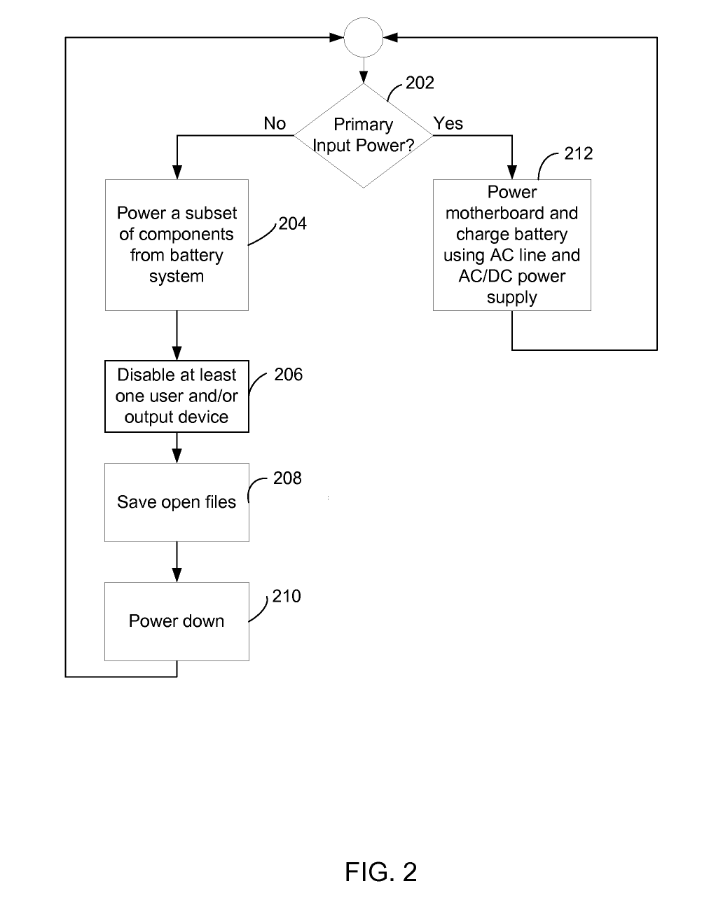

FIG. 2 is a flowchart depicting one exemplary method wherein a computer executes a power down sequence in the event of a power interruption. At the outset, determination functionality 202 performed by UPS 106, i.e., power sensing logic 108, determines that DC voltage 132 is either not present or is insufficient to power the components of computer housing 102. If DC voltage 132 is present and is sufficient to power computer housing 102, primary input source functionality 212 configures UPS 106 to supply motherboard 116 with DC power derived from line input 130. Functionality 212 enables battery and power regulator module 114 to receive input power to maintain the battery at full charge.

Returning to determination functionality 202, based upon a determination that DC input voltage 132 is below one or more predetermined threshold, switch 110 is configured to switch the output 138 of battery and regulator module 114 to motherboard 116 over cable 140. In some embodiments, switch 110 is controlled by control logic 160. In other embodiments, power sensing unit 108 controls switch 110 directly. Furthermore, in some embodiments, a subset of computer components configured to receive battery power include: motherboard 116 and drive 120.

Disabling functionality 206 is operable to disable at least one of user inputs e.g., keyboard 122 and mouse 124, and/or outputs, e.g., display 126, to preclude the user from interfering with file saving functionality 208 performed by power down logic 162.

In one embodiment, power down functionality 210 is operable to place computer 100 in either a shutdown state, whereby the user may power up computer 100 once primary power has been restored. In other embodiments, power down functionality 210 is operable to place computer 100 in a state of hibernation that may be reactivated automatically when primary power is restored, or may require user initiation to power up the computer.

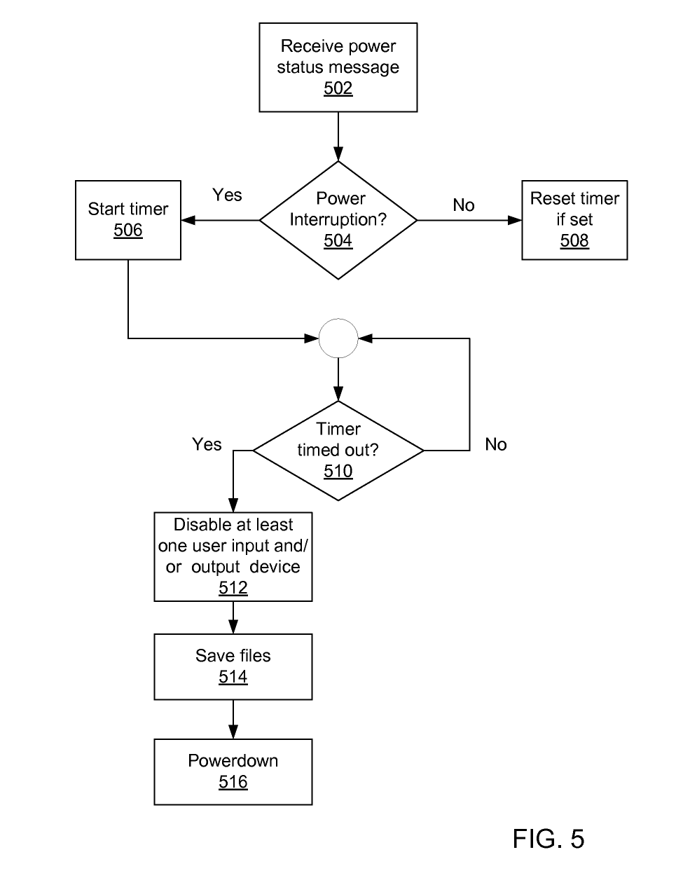

In some power environments, power interruptions of one or two seconds are common and to initiate a file saving process in these situations would be counterproductive. Accordingly, FIG. 5 depicts a flowchart according to another embodiment wherein file saving functionality 208 is performed only if a detected power interruption is longer than a predetermined period of time, e.g., 15 seconds, 30 seconds, one minute, and etc., based upon the capability of the battery to sustain computer operation. Functionality 502 includes motherboard 116 receiving a change of status message from UPS 106. In some embodiments, status monitoring functionality 504 determines that the message from UPS 106 indicates an interruption of primary power, based upon a predetermined threshold of DC power 132 and turns control over to delay functionality 506 that starts a timer, implemented in either hardware or software, that delays disabling functionality 512, file saving functionality 514, and shutdown functionality 516.

If, after the timer is initiated at functionality 506, but before it is allowed to time out, a subsequent UPS status message is received indicating that power has been restored, functionality 508 resets the timer so as not to implement functionalities 512 and 514.

After power down logic 162 has saved all open files, or based upon a preset voltage threshold level detected by the battery and power regulator module 114, power down functionality 210 is operable to cause power down logic 162 to power down computer housing 102 or place motherboard 116 in a hibernating state.

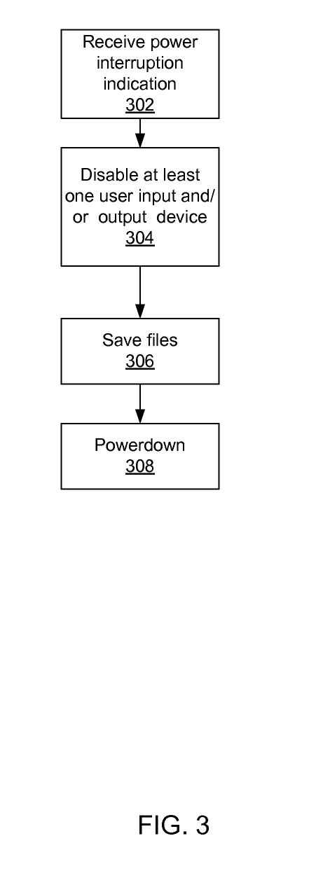

FIG. 3 depicts an exemplary flowchart of functions performed by power down logic 162. Message receiving function 302 receives one or more power status signals from UPS 106, including but not limited to whether any voltage, e.g., output voltage 132 and output 138 from battery and power regulator 112, and the source of power received on cable 110, is below a predetermined threshold. Upon receipt of a status signal indicating failure of primary input power, disabling functionality 304 disables at least one of user input/output devices to prevent user interference with file saving operations and to minimize further power expenditure that may further drain the battery. In some embodiments, disabling functionality 304 may disable user input while allowing at least a subset, i.e., display device 126, to function in order to provide status/feedback to the user.

File save functionality 306 operates to determine zero or more files to save. In some embodiments, determination is based upon applications actively running on the computer as determined by the operation system of the computer. In at least some embodiments, power down logic 162 operable in conjunction with the computer operating system and/or BIOS determines open files and save them to drive 120. In other embodiments, open files unassociated with a storage medium, new data residing only in random access memory, is stored to drive 120 based upon a predetermined naming schema.

In some embodiments, after file saving functionality 306, power down functionality 308 is operable, based upon power down logic 162, to place CPU 156 in hibernation mode. In other embodiments, power down logic 162 is operable to power down one or more of motherboard 152, UPS 106, and AC to DC power supply 104.

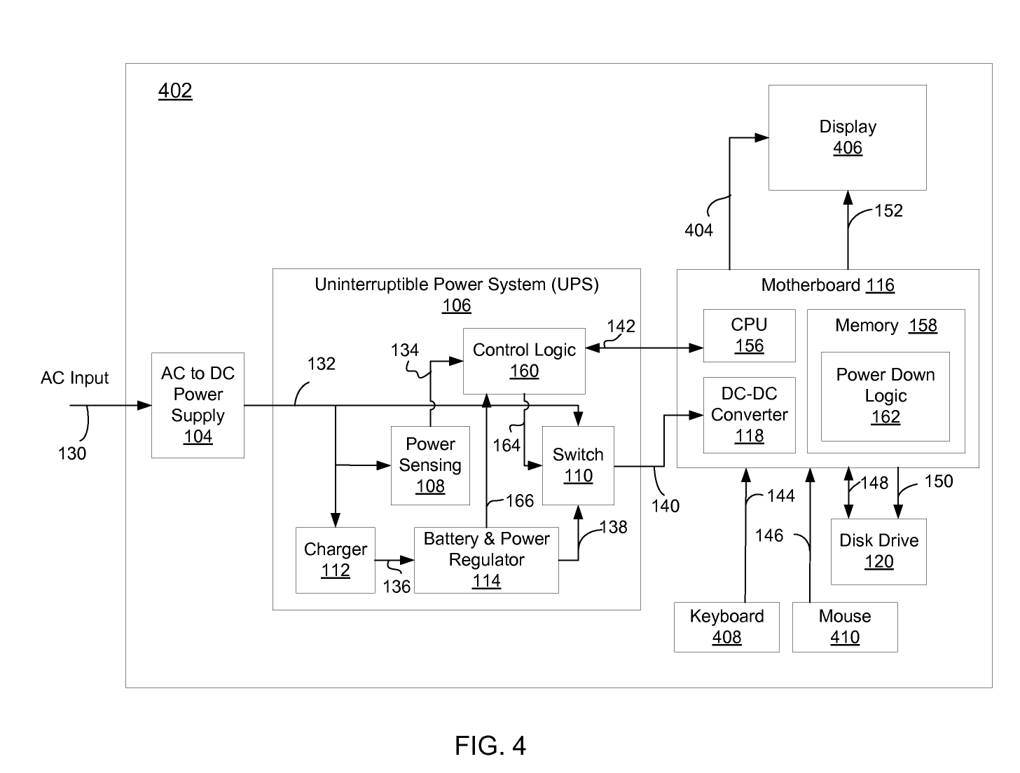

FIG. 4 is a block diagram of another embodiment wherein display device 406 is integral to computer housing 402 and is supplied by a DC voltage 404 supplied by motherboard 116. In this embodiment, power down logic 162 is operable to disable DC input voltage 404 to display 406 when operating on battery power. In at least one other embodiment, display 404 derives it power directly from AC to DC power supply 104, thereby precluding power down logic 162 from having to disable the power input to the display. In other embodiments, in addition to motherboard 116, at least a subset of other computer components, e.g., display 406, are powered directly from UPS 106 via another switch 110.

What is claimed is:

1. A method of managing power on a computer in the event of a power interruption, comprising:
monitoring primary input power to a computer;
delivering battery derived power from a battery internal to the computer to a subset of the computer's components;
disabling power to at least one of a user input device or a user output device;
saving zero or more open files to a storage device; and
powering down the computer.

2. The method of claim 1, wherein delivering battery derived power to a subset of the computer's components excludes delivering power to a display device.

3. The method of claim 1, wherein disabling at least one user input comprises disabling input from an attached pointing device and/or keyboard.

4. The method of claim 1, wherein powering down the computer comprises placing the computer in hibernation mode.

5. The method of claim 1, wherein the saving zero or more open files to a storage device is performed based upon a predetermined naming schema.

6. The method of claim 1, wherein the saving of zero or more open files is performed after an interruption of primary input power for a predetermined time.

7. A method of powering down a computer in the event of a power interruption, comprising executing a power down sequence that comprises:
receiving at least one power status indication;
switching a power source from an external primary input power source to an internal secondary input power source in response to receiving an indication of loss of primary input power to a computer;
disabling power to at least one of a user input device or a user output device;
saving zero or more files to a storage device; and
powering down the computer.

8. The method of claim 7, wherein disabling user inputs includes disabling at least one of a keyboard and a pointing device.

9. The method of claim 7, further comprising disabling power to a computer connected display device while executing the power down sequence.

10. The method of claim 7, further comprising placing the computer in hibernation mode.

11. The method of claim 7, further comprising determining the zero or more files to save to the storage device.

12. The method of claim 7, further comprising awakening the computer from hibernation mode and enabling disabled user devices upon receipt of an indication of primary input power.

13. The method of claim 7, wherein disabling at least one user input includes disabling at least one of a keyboard and pointing device.

14. A computer computer-readable medium comprising a set of instructions which, when executed by a processor, cause the processor to:
to receive an indication of loss of primary input power to a computer;
to disable at least one user output device;
save zero or more files to a storage device; and
power down the computer.

15. A computer comprising a housing, wherein the housing further comprising:
a source of primary input power;
a uninterruptible power system (UPS) comprising at least one battery and a control logic, the UPS configured to receive a low DC voltage derived from the source of primary input power and generate an DC output voltage selected from one of the primary input power and the at least one battery and power regulator, the UPS further configured to communicate a status signal;
a computer motherboard configured to receive the DC output voltage and the status signal, the motherboard further configured to disable at least a subset of devices and save open files to a storage medium.

16. The computer of claim 15, wherein the computer is a desktop computer configured to be connected to an external display device that receives input power independent of the motherboard and the UPS.

17. The computer of claim 15, wherein the computer comprises an internal display device that derives power from the motherboard only when the motherboard is powered by the primary input power source.

18. The computer of claim 15, wherein the battery and power regulator is sized to only supply sufficient power to save open files.
